(19) United States
(12) Patent Application Publication
(10) Pub. No.: US 2017/0113398 A1
(43) Pub. Date: Apr. 27, 2017

(54) Weldable profile and associated method for welding plastic panels

(71) Applicants: Farhooman Davoudi, Roissy En Brie (FR); ASM, Guerande (FR)

(72) Inventor: Farhooman Davoudi, Roissy En Brie (FR)

(21) Appl. No.: 15/267,559

(22) Filed: Sep. 16, 2016

(30) Foreign Application Priority Data
Sep. 16, 2015 (FR) 1570040
Sep. 29, 2015 (FR) 1559216

(51) Int. Cl. B29C 65/02; B29C 65/00

(52) U.S. Cl. CPC B29C 65/02; B29C 66/8362; B29C 66/10; B29L 2007/002

(57) ABSTRACT

Welding rod for performing a plastic weld on plastic panels, so as to fasten them to one another, and related methods. Use of welding rods, or structural and welding profiles, having at least one tongue below which is a boss extending longitudinally and forming a material reserve. Once the welding rod is placed along a desired weld line, under the effect of heating, the material reserve is softened and fuses with a panel portion situated opposite it, so as to produce a final plastic weld, and the tongue is folded down on said weld line, to conceal it.

### FIELD OF ART

The invention relates to welding plastic panels, such as floor or wall covering panels or self-supporting panels, connected to one another by structural profiles and welded via a welding rod, using a plastic welding technique.

More specifically, the present invention particularly relates to a welding rod or a structural and welding profile including the features of such a welding rod, and an associated welding method, the welding rod including at least one tongue covering a panel portion to be welded, said at least one tongue having an integrated material reserve intended for fusing with the panel portion situated opposite it, to perform the definitive plastic welding of the juxtaposed panels. The invention also relates to a method for performing, using an appropriate tool and a profile integrating or cooperating with such a welding rod, the welding of plastic panels, in particular composite.

### BACKGROUND

The general issue relates to the plastic welding of panels, in particular composite plastic panels, using welding rods, said panels being assembled via structural profiles. According to the invention, said welding rods may be integrated into said structural profiles or may be separate therefrom.

It is known that panels, such as floor or wall covering panels, or self-supporting panels for example to form shower stalls, can be welded to one another using a plastic welding technique. Plastic welding, as known by those skilled in the art, consists of welding two plastic bodies to one another by heating a volume at the interface between the two bodies and added material, such as a welding rod, so as to soften the plastic material of the two bodies opposite one another and said added material, such that the material of said two bodies fuses with said added material, i.e., typically a welding rod, thus performing the definitive welding of the two bodies to one another, the two bodies generally also being kept pressed against one another.

In this context, the state of the art comprises various examples of plastic welding methods using welding profiles, to fasten juxtaposed panels to one another, such as plastic panels.

Document WO 2013/132406 thus describes one example welding method for plastic panels, in particular composite.

However, the known plastic welding methods making it possible to weld plastic profiles and assemble panels made from plastic have various drawbacks, related on the one hand to the technicality required to implement them, and on the other hand to the poor aesthetic performance of the welds done using these methods.

Indeed, the known plastic welding methods require, to be implemented, technical know-how that only professionals have. Thus, to weld two plastic panels correctly, after having correctly positioned panels to be welded, bevel against bevel, having flanged them to keep them in place during the welding and having tacked the two panels, it is essential, today, to control both a contribution of outside plastic material making it possible to produce the weld, said added plastic material assuming the form of a plastic rod, and the heating of the exact volume, at the interface between the panels to be welded, making it possible to soften the two panels and the plastic welding rod, so as to allow them to fuse, but without softening the material beyond the volume necessary to perform the welding. It is further crucial to advance at a very precise speed, so as to cause the necessary softening of the material of the two panels to be welded and the plastic welding rod, at the risk of the weld not taking, and without heating the material excessively, at the risk of causing aesthetically displeasing burns. Lastly, at the end of the weld line, the plastic welding rod must be cut carefully, which is often the source of another aesthetic flaw.

In practice, this makes it practically impossible for an individual to carry out such a plastic welding operation. Indeed, generally, even a professional does not manage to produce a perfect weld, small burns most often remaining at one location or another around the weld line, most often at the beginning of said weld line, and the weld line not being perfectly smooth.

Today, to try to offset this drawback, tools have been developed, in particular comprising a heating nozzle making it possible to perform the desired heating, and also comprising a guide in order to guide the addition of plastic material in front of the heating nozzle, and automatically bring it forward over time.

However, although these tools eliminate some of the complexity of the operation, they do not prevent burns from occurring along the weld line and still require use by a seasoned and specialized technician.

Furthermore, it remains necessary to add an outside material, which involves managing, during a welding operation, the positioning of the panels, the positioning of the added material (to be cut at the end of the weld line), and the advancement of the tool (heating nozzle in particular) all at the same time.

Lastly, the aesthetic performance is also still altered by the fact that the weld line cannot be perfectly smooth.

Furthermore, in the particular context of producing structures made up of plastic, self-supporting panels, such as shower stalls for example, the current plastic welding methods are not suitable because they do not make it possible to obtain a tight enough final weld. As a result, the current techniques for forming such self-supporting structures consist of thermoforming wide plastic sheets to obtain the desired shape of the structure. Yet these thermoforming techniques consume extremely large quantities of energy, which is harmful both economically and environmentally speaking.

There is therefore a need for welding profile—also called rod—and an associated plastic welding method making it possible to weld plastic panels easily, in particular composite panels, while obtaining an improved aesthetic result.

To that end, the present invention makes it possible to produce a final and tight plastic weld of plastic panels, in particular composite panels, without requiring the addition of an outside material to perform the welding and with an improved aesthetic result.

The method according to the invention in particular makes it possible to produce self-supporting structures, such as shower stalls, made by assembling panels welded to one another permanently and tightly, and therefore without requiring the implementation of energy-intensive thermoforming techniques.

In this context, the invention relates to a welding rod, or a welding profile, integrated or able to be inserted in a structural profile acting as an interface between two panels to be welded, said welding rod comprising at least one tongue, alongside a central body situated at the interface between said panels. Said at least one tongue comprises, below its surface, on the side of the panel to be welded, a reserve of plastic material constituting the added plastic material for the welding operation. The added material is consequently integrated into the welding profile according to the invention. The tongue(s) is (are) further dimensioned to be folded down along the weld lines, making it possible to hide said weld line and any imperfections thereof (small burns and smooth appearance, in particular).

The present invention also relates to a plastic welding method implementing such a welding rod, as well as a tool dedicated to carrying out said method.

### SUMMARY

To that end, more specifically, the invention relates to a welding rod, for welding juxtaposed plastic panels, said welding rod having a central body extending longitudinally over the entire length of the welding rod.

Said welding rod is remarkable in that it comprises at least one tongue alongside the central body, said tongue extending longitudinally over the entire length of said welding rod and said tongue being able to cover a small portion of a panel situated opposite it, and in that said tongue includes a flat base and a boss extending longitudinally over the entire length of said welding rod, opposite a panel to be welded, said boss forming a reserve of plastic material configured to fuse with the panel portion situated opposite it, under the effect of appropriate heating of the volume comprising said material reserve (2) and said panel portion situated opposite it, such that the softened material of the material reserve and the softened panel fuse so as to create a final plastic weld between the welding rod and said panel.

According to one embodiment, the welding rod is intended to be adapted on a structural profile or integrated into the mass of a structural profile, said welding rod being intended to cooperate with the structural profile acting as the interface between the juxtaposed panels and the flanging of said panels.

According to one embodiment, the boss forming the reserve of plastic material further comprises at least one protuberance smaller than said boss forming a reserve of plastic material, said at least one protuberance forming a sub-reserve of plastic material, smaller than a reserve of plastic material, said sub-reserve of material being situated in the heating volume, its smaller size being configured to cause a softening of said sub-reserve more quickly than the softening of the reserve of plastic material, so as to perform tacking prior to the final plastic welding.

Advantageously, the material reserve is situated at a determined distance from the panel situated opposite it, said determined distance being configured such that the heating of the volume comprising the material reserve and the panel portion situated opposite it causes only partial heating and not melting of the flat base of the tongue or of the central body of the welding rod.

According to one embodiment, the tongue comprises at least one secondary boss, extending longitudinally over the entire length of said welding rod and situated outside the heating volume, between the material reserve and the central body, to form a sealing dam.

According to one embodiment, the welding rod comprises at least two tongues, said two tongues being situated on either side of the central body, and said two tongues being intended to be found respectively opposite two panels to be welded to one another via said welding rod.

The present invention also relates to a structural and welding profile acting as a link between plastic panels, such as floor or wall covering panels or self-supporting panels, including at least one welding rod integrated into the mass of said structural and welding profile.

According to another embodiment, the present invention also consists of a structural and welding profile assembly, comprising a structural profile and at least one welding rod as briefly described above, said structural profile having at least one housing able to receive the insertion of said at least one welding rod.

For example, such a structural and welding profile assembly can comprise an aluminum structural profile and at least one plastic welding rod.

The present invention also relates to a method for welding plastic panels, comprising the following steps:

i. positioning at least two juxtaposed panels, connected to one another and maintained by appropriate flanging means, such as a structural profile;

ii. positioning a welding rod as briefly described above, such that said at least one tongue of said welding rod coincides with a desired weld line on a panel;

iii. using a tool having a heating nozzle and appropriate means for folding down said at least one tongue, such as a roller:
a. heating, using the heating nozzle, a volume comprising the reserve plastic material of said at least one tongue of the welding rod and a portion of the panel situated opposite it, so as to soften the reserve of plastic material on the one hand and the panel portion situated opposite it on the other hand, such that the softened material reserve and softened panel portion fuse, ensuring plastic welding of the welding rod and the panel;
b. flattening, using the appropriate means, such as a roller, said at least one tongue of the welding rod so as to conceal the weld line.

The present invention also relates to a dedicated tool for plastic welding of a welding profile on plastic panels comprising a heating nozzle at one end, the other end corresponding to a gripping zone, and a means suitable for folding down a tongue, such as a roller, on the side of the end where the heating nozzle is located and upstream from the latter, said heating nozzle and said means suitable for folding down said tongue being configured to carry out step iii. of the method described above.

### BRIEF DESCRIPTION OF THE DRAWINGS

The invention will be better understood upon reading the following description, provided solely as an example and done in reference to the appended drawings, in which:

FIG. 1 shows an example of a structural and welding profile according to the invention;

FIG. 2 shows an assembly of a structural profile and a plurality of welding rods, together forming a profile according to the present invention;

FIG. 3 shows the head of a tool dedicated to carrying out the welding method according to the invention;

FIG. 4 shows the implementation of the dedicated tool for carrying out the welding method according to the present invention;

FIG. 5 shows part of the welding rod or a structural and welding profile according to the invention, the material reserve being at a determined distance from the panel to be welded;

FIG. 6 shows part of the welding rod or a structural and welding profile according to the invention, the material reserve comprising a protuberance making it possible to perform tacking before the final welding;

FIG. 7 shows a structural and welding profile with sealing dams to ensure sealing of the weld;

FIG. 8 shows an example of a welding rod with a protuberance; and

FIG. 9 shows another example of a welding rod according to the invention.

### DETAILED DESCRIPTION

The invention is primarily presented for an application to plastic welding of plastic panels, in particular composites, such as covering panels or self-supporting panels for example to form shower stalls. Such panels are assembled using structural profiles forming, as their name indicates, a structure on which a plurality of panels are assembled and guided in their position. In this context, the present invention in particular proposes a structural and welding profile, with integrated added material, making it possible to accelerate and facilitate the welding of such plastic panels, in particular composite panels, to one another.

In reference to FIG. 1, the present invention in particular relates to a plastic structural profile 15, incorporating a welding rod 1, thus forming a single-piece structural and welding profile 15.

It should be noted that, according to other embodiments, the welding rod 1, made from plastic, may be separate from the structural profile 10 and be housed in housings arranged on said profile, for the welding operation.

The embodiment shown in FIG. 1 therefore consists of a single-piece welding profile, made from plastic, and incorporating the characteristics of a plurality of welding rods 1.

Said structural and welding profile 15 comprises a central body intended, during the welding operation, to be positioned at the interface between juxtaposed panels to be welded. On either side of the central body, the structural and welding profile shown in FIG. 1 comprises the specific characteristics of welding rods 1 according to the invention, assuming the form of flexible or rigid tongues 31, each tongue 31 having a flat base and a boss forming a plastic material reserve 2, constituting the addition of material useful for the plastic welding of the panels. Said tongues 31 and said bosses 2 extend longitudinally, over the entire length of the structural and welding profile 15.

The Welding Method

In practice, to weld two plastic panels according to the present invention it is provided to position the panels to be welded 51, 52 such that their edges are opposite one another, guided by a structural profile that may be positioned at the interface between the panels to be welded.

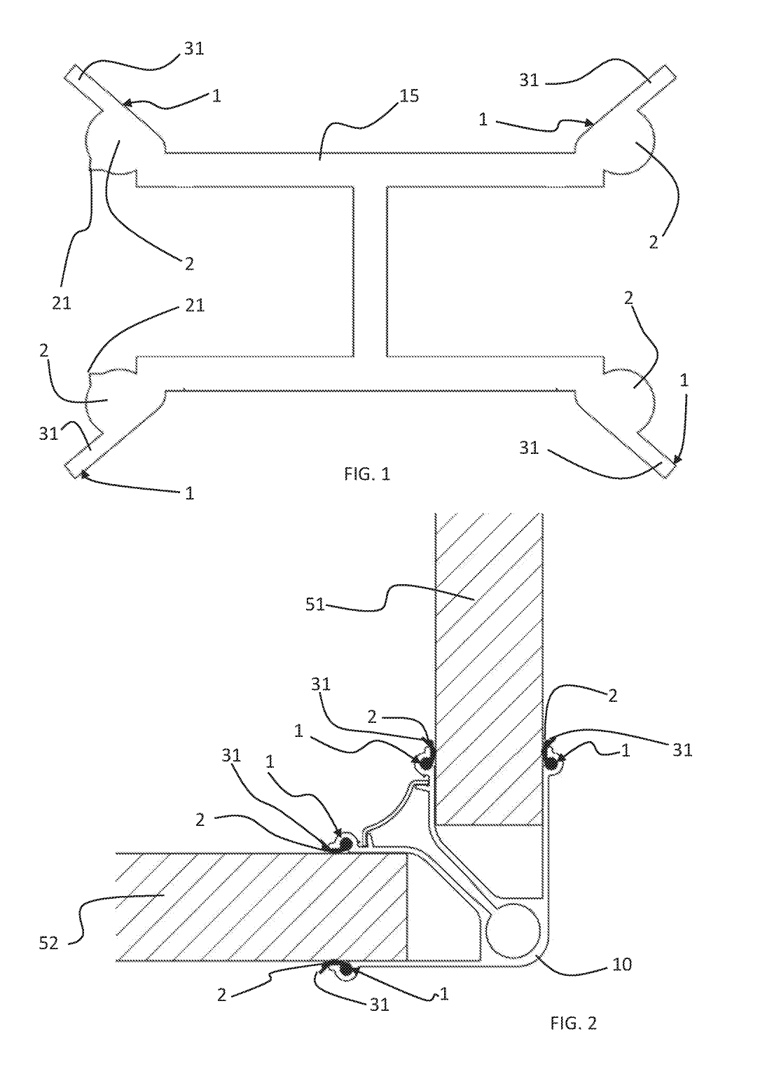

Said panels 51, 52 are thus juxtaposed and pre-positioned using a structural profile 10, 15, which either integrates the characteristics of welding rods, as shown in FIG. 1, or is able to receive and cooperate with at least one such welding rod, as shown in FIG. 2.

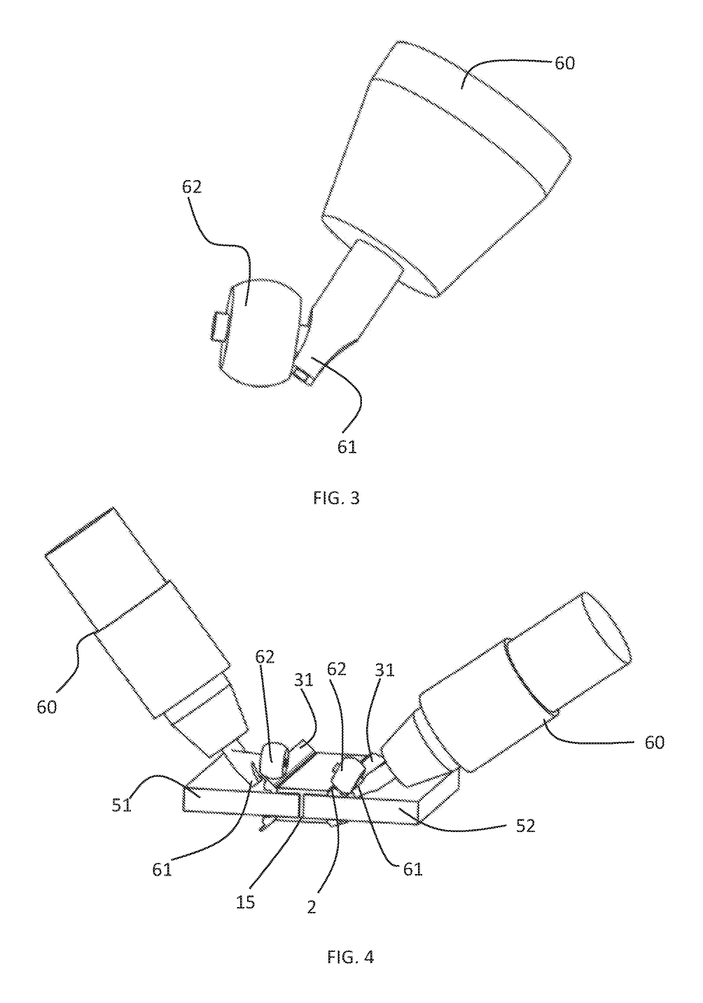

Using a heating nozzle, or preferably, using a special tool 60 (shown in FIGS. 3 and 4) comprising both a heating nozzle 61 and a roller 62 able to flatten the tongue 31 during the welding operation, as will be described below, a volume going from the material reserve to the panel portion situated opposite it is heated.

The plastic material situated in this volume is thus softened, melted. As a result, the plastic material comprised in the boss 2 below each tongue 31 and the portion of each panel 51, 52 situated opposite it, fuse, thus producing the final plastic welding of the panels to one another, via the welding rod(s) 1.

Preferably using the roller of the dedicated tool 60 mentioned above, each tongue 31 of the welding rod(s) 1 or the structural and welding profile 15 is next flattened and covers the weld line on each panel.

In other words, using the dedicated tool 60 shown in FIG. 3, comprising a heating novel 61 and a roller 62 able to flatten the tongue 31 on either side of the central body of the welding rod 1, the plastic welding of two panels 51, 52 can thus be done in a single passage over each tongue 31, automatically.

In reference to FIG. 4, indeed, the shape of the welding rod 1 or the structural and welding profile 15 and that of the head of the dedicated tool are suitable and configured so that the heating nozzle 61 only heats the necessary volume, comprising the material reserve 2 and the panel portion situated opposite it. Under the effect of this heating, as previously described, the plastic welding occurs. In parallel, the roller 62 situated upstream from the heating nozzle 61, as the tool advances along the weld line, flattens the tongue 31, which covers said weld line, thereby concealing any surface imperfections (protrusions, burns), and making it possible to obtain an optimal aesthetic appearance.

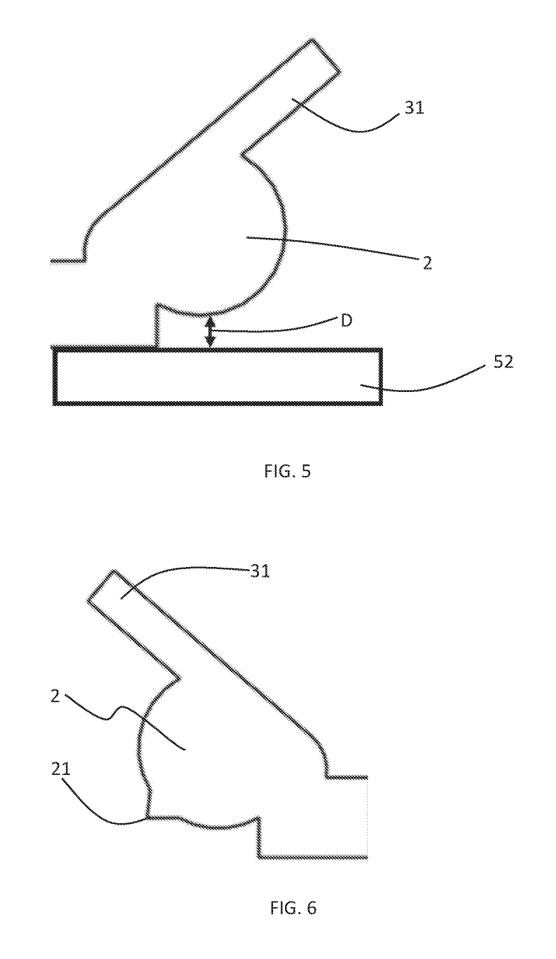

According to the embodiment shown in FIG. 5, the welding rod 1, or the structural and welding profile 15, is further configured such that each material reserve 2 is found, after placing the structural profile and the welding rod 1, or the structural and welding profile 15, at the interface between the panels 51, 52 to be welded, before the welding operation, at a suitable distance D from the panel to be welded situated opposite it, this distance D being at least 1 mm, such that, during its passage to perform the welding operation, the heating nozzle 61 of the implemented tool precisely heats the desired volume, comprising the reserve of plastic material 2 and the panel portion opposite it, and not, in particular, the flat base of the tongue 31, which is only partially heated and is neither softened nor melted during the welding operation.

Thus, the flat base of the tongue 31 is not heated directly, and is only partially heated. It is therefore not softened, much less melted, but the tongue 31 is folded down on the weld line, after melting of the material reserve 2, for example assisted to that end by the adapted roller 62 upstream from the heating nozzle 61 on the dedicated tool 60 previously described.

Furthermore, according to one submitted embodiment, shown in FIG. 6, each boss 2 may comprise at least protuberance 21, typically one or two tips, able to produce the equivalent of tacking during the welding operation. Indeed, during the heating of the volume going from the material reserve to the panel portion situated opposite it, said at least one protuberance 21, which has a reduced volume relative to the material reserve 2 and the panel portion situated opposite it, softens and melts more quickly, so as to produce at least a small weld spot just before the final welding is done during the fusion of the material reserve with the panel portion situated opposite it.

Once the tongue 31 is folded down, the profile 10, 15 is placed, which means that the boss 2 is melted and the material has fused with the softened and partially melted material of the panel portion opposite it; in other words, the final plastic welding is then done. The flat base of the tongue 31, covering the weld line, ensures an optimal aesthetic appearance of the weld.

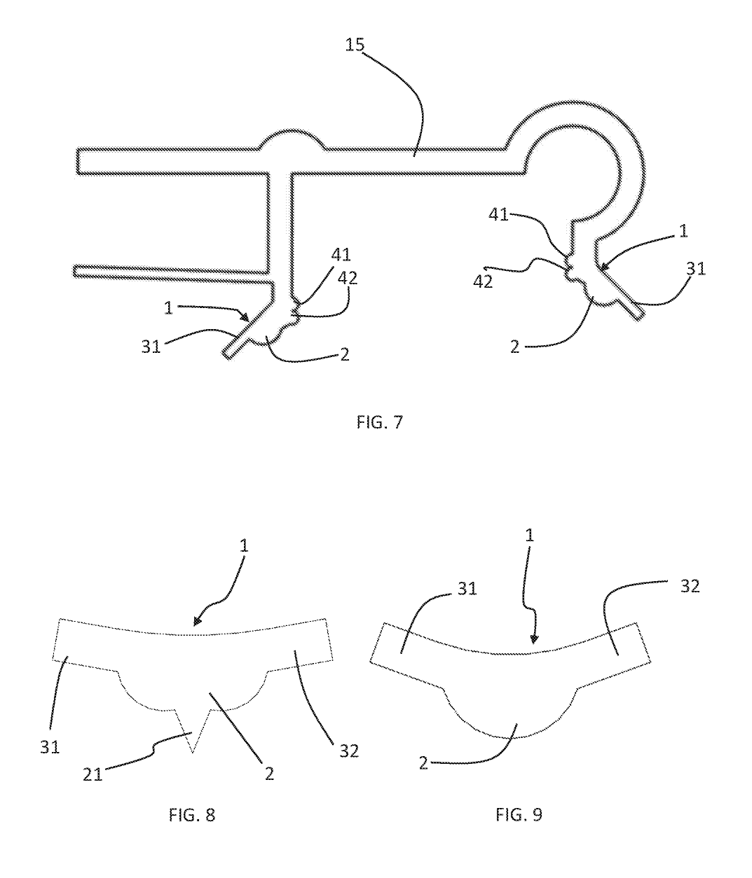

According to one submitted embodiment, the welding rod 1, or the structural and welding profile 15, may also comprise at least one protuberance, and preferably two protuberances 41, 42, between the material reserve 2 and the central body, as shown in FIG. 7. This or these protuberances 41, 42 form a sealing damn making it possible to ensure proper sealing of the weld.

The shape of the structural profile 10, 15, whether or not it integrates the welding rod 1 into its mass, may further also be adapted so as to improve the sealing of the assembly of panels.

As previously mentioned, the present invention in particular relates to a welding rod 1 making it possible to perform plastic welds quickly and easily. This welding rod 1 may be integrated into the mass of a plastic structural profile 15, the characteristics of which (shape, dimensions, etc.) are adapted based on the panels to be welded, as shown in FIG. 1. In FIG. 2, conversely, a plurality of welding rods 1 independent of the structural profile 10 are implemented. Said structural profile thus performs flanging and allows the positioning of the panels to be welded. Furthermore, this structural profile 10 includes housings, such as guides, in which the welding rods 1 can be housed.

Typically, the structural profile 10 can thus be made from aluminum, while the welding rods 1 remain made from plastic, with characteristics (shape, dimensions, etc.) adapted based on the panels to be welded, thereby forming, after assembly, a bi-material structural and welding profile. For the rest, the operating principle of these welding rods 1 and the associated welding method remain unchanged: using a suitable tool 60, preferably comprising a heating nozzle 61 and a roller 62 placed behind the heating nozzle 61 situated at the end of the tool, the material reserve 2 present below the tongue 31 of the welding rod 1 is heated at the same time as a portion of the panel 51, 52 situated opposite it. The fusion between this material reserve 2 and this panel portion situated opposite it performs the definitive welding. The protuberances 41, 42 provided between the material reserve and the central body perform the sealing dam function.

Preferably, the shape of the structural profile 10 is further adapted to comprise specific housings provided to receive the plastic material originally contained in the boss 2 and melted during the welding operation. These specific housings have a shape suitable for avoiding any withdrawal of melted plastic material having penetrated therein. Said specific housings for receiving the melted plastic material perform a non-return function of said melted plastic material outside the structural profile 10, after welding, making it possible to obtain a particularly meticulous weld line.

In summary, the present invention relates to a plastic welding method, a welding rod 1 and a dedicated tool 60 for quickly and easily assembling plastic panels 51, 52, in particular composite panels, definitively and sealably.

A particular application to the production of self-supporting shower stalls is possible, the present invention making it possible to eliminate the implementation of costly thermoforming operations.

It should further be noted that the invention is not limited to the embodiment described as an example and is open to alternatives within the reach of one skilled in the art.

As shown by all of the figures, the shape of the structural and welding profile 15 or the structural profile 10 intended to cooperate with one or several welding rods 1, as well as the shape of said rods, if applicable, may be adapted. The configuration of these shapes is possible at will and makes it possible to produce any type of assembly, involving two or more panels, which may or may not form angles relative to one another.

Furthermore, the welding rods 1 previously described are in particular provided to cooperate with a structural profile 10 providing the interface between the panel 51, 52 to be welded, as well as flanging thereof. However, the welding rods 1 according to the invention may also be implemented for welding plastic panels, the latter being flanged by means other than a structural profile.

As an example, FIGS. 8 and 9 thus show a welding rod 1 comprising two tongues 31, 32 situated on either side of the central body of the welding rod 1, said tongues 31, 32 each comprising a material reserve 2, said two tongues 31, 32 being intended to be found respectively opposite two composite panels to be welded to one another via said welding rod.

In FIG. 8, the welding rod 1 further comprises a protuberance 21, intended to perform tacking.

In these examples, the welding rods 1 are suitable for allowing the welding of juxtaposed panels, the latter not necessarily being flanged via a structural profile. Indeed, said panels can be flanged by any other suitable means.

Other alternatives are also possible and within the reach of one skilled in the art.

1. A welding rod, for welding juxtaposed plastic panels, said welding rod having a central body extending longitudinally over the entire length of the welding rod, and said welding rod comprising at least one tongue alongside the central body, said tongue extending longitudinally over the entire length of said welding rod and said tongue being able to cover a small portion of a panel situated opposite it, and said tongue including a flat base and a boss extending longitudinally over the entire length of said welding rod, opposite a panel to be welded, said boss forming a reserve of plastic material configured to fuse with the panel portion situated opposite it, under the effect of appropriate heating of the volume comprising said material reserve and said panel portion situated opposite it, so as to create a final plastic weld between the welding rod and said panel.

2. The welding rod according to claim 1, intended to be adapted on a structural profile or integrated into the mass of a structural profile, said welding rod being intended to cooperate with the structural profile acting as the interface between the juxtaposed panels and the flanging of said panels.

3. The welding rod according to claim 1, wherein the boss forming the reserve of plastic material further comprises at least one protuberance smaller than said boss forming a reserve of plastic material, said at least one protuberance forming a sub-reserve of plastic material, smaller than the reserve of plastic material, said sub-reserve of material being situated in the heating volume, its smaller size being configured to cause a softening of said sub-reserve more quickly than the softening of the reserve of plastic material, so as to perform tacking prior to the final plastic welding.

4. The welding rod according to claim 1, wherein the material reserve is situated at a determined distance from the panel situated opposite it, said determined distance being configured such that the heating of the volume comprising the material reserve and the panel portion situated opposite it causes only partial heating and not melting of the flat base of the tongue or of the central body of the welding rod.

5. The welding rod according to claim 3, wherein the material reserve is situated at a determined distance from the panel situated opposite it, said determined distance being configured such that the heating of the volume comprising the material reserve and the panel portion situated opposite it causes only partial heating and not melting of the flat base of the tongue or of the central body of the welding rod.

6. The welding rod according to claim 5, wherein the tongue comprises at least one secondary boss, extending longitudinally over the entire length of said welding rod and situated outside the heating volume, between the material reserve and the central body, to form a sealing dam.

7. The welding rod according to claim 1, comprising at least two tongues, said two tongues being situated on either side of the central body, and said two tongues being intended to be found respectively opposite two panels to be welded to one another via said welding rod.

8. A structural and welding profile assembly, comprising a structural profile and at least one welding rod according to claim 1, said structural profile acting as a link between plastic panels, such as floor or wall covering panels or self-supporting panels.

9. The structural and welding profile assembly according to the claim 8, the structural profile being made from aluminum and said at least one welding rod being made from plastic.

10. A method for welding plastic panels, comprising the steps:
i. positioning at least two juxtaposed panels, connected to one another and maintained by appropriate flanging means, such as a structural profile;
ii. positioning a welding rod according to claim 1, such that said at least one tongue of said welding rod coincides with a desired weld line on a panel;
iii. using a tool having a heating nozzle and appropriate means for folding down said at least one tongue, such as a roller:
a. heating, using the heating nozzle, a volume comprising the reserve plastic material of said at least one tongue of the welding rod and a portion of the panel situated opposite it, so as to soften the reserve of plastic material on the one hand and the panel portion situated opposite it on the other hand, such that the softened material reserve and softened panel portion fuse, ensuring plastic welding of the welding rod and the panel;
b. flattening, using the appropriate means, such as a roller, said at least one tongue of the welding rod so as to conceal the weld line.
